(19) United States
(12) Patent Application Publication
(10) Pub. No.: US 2006/0108458 A1
(43) Pub. Date: May 25, 2006

(54) Method and device for processing biowaste

(76) Inventor: Joachim Steinbeck, Gorisried (DE)

Correspondence Address: JACOBSON, PRICE, HOLMAN & STERN;Professional Limited Liability Company, 400 Seventh Street, N.W., Washington, DC, 20004, US

(21) Appl. No.: 11/168,877

(22) Filed: Jun. 29, 2005

(30) Foreign Application Priority Data
Nov. 22, 2004 (DE) 10 2004 056 347.0

(51) Int. Cl. B02C 23/00

(52) U.S. Cl. 241/24.1; 241/34

(57) ABSTRACT

The invention refers to a method and a device for processing biowaste. A comminution mill is provided after which a separation device for solid materials and liquids is arranged. A control monitors pressure, respectively flow, of the biowaste ground by the comminution mill, and adjusts, depending on these monitored values, a pump which is arranged before the separation device.

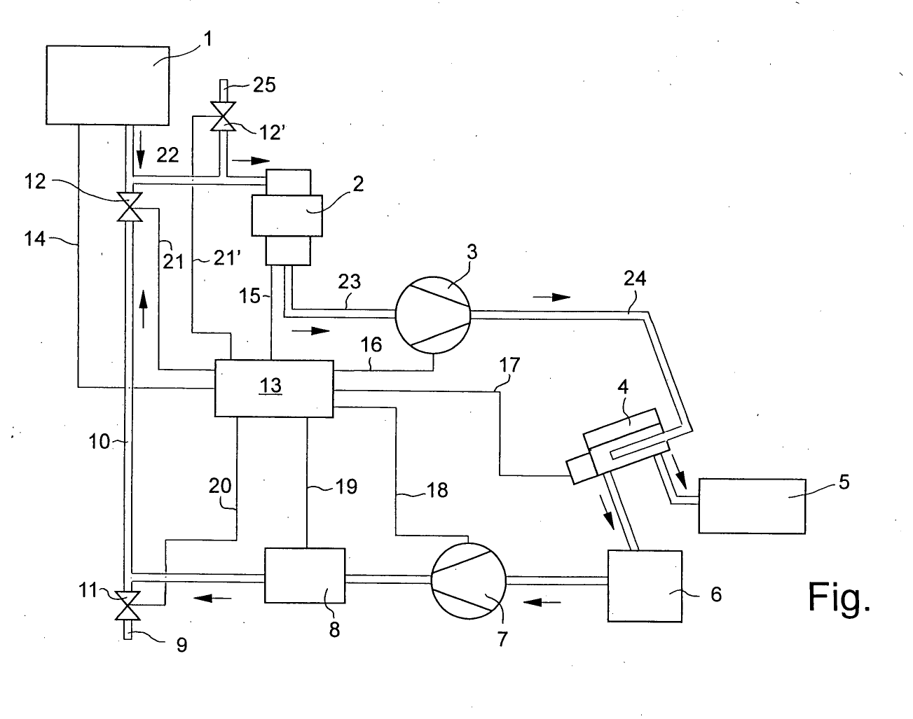

The invention refers to a method and a device for processing biowaste, comprising a comminution mill and a separation device which is arranged after it for solid materials and liquids.

### BACKGROUND OF THE INVENTION

Devices mentioned above are known, for example, from the German patent application 101 08 495.1 by the applicant. They are used for processing organic waste of the type which occurs in the food processing industry and in joint catering institutions like, for example, canteen kitchens, canteens or in big events. In particular the processing of biowaste is supposed to make its disposal easier.

In order to dispose of this biowaste it has been known, to use it, for example, in agriculture as food. However, because of epidemic-hygienic regulations this biowaste has to be pre-processed in a suitably expensive manner.

Organic waste has a very high content of water of up to 80%. These are often leftovers of fruit and vegetable, fish and meat waste, however, possibly also waste with a relatively high liquid content like soups or sauces etc.

It is known in the state of the art to process, respectively dispose of, this biowaste in such a way that it is conveyed, first of all, to comminution mill, and, after that, the ground, respectively crumbled, biowaste is conveyed to a separation device which is arranged after the comminution mill. The separation device has here the task to separate the solid content of the biowaste from the liquids.

By means of that it is achieved to reduce volume and mass of the biowaste considerably, and to make the solid material in a certain way even suitable for storage in order to use it, for example, for the production of biogas for current generation. The mass is reduced by removing the liquid, at the same time the biomass is compressed by crumbling and removing the liquid.

On the other hand, it is possible to pass the liquid, for example, directly into the drain.

The known devices therefore already provide an economic modification for processing, respectively disposing of, biowaste.

For use, for example, in grocery stores where possibly in the fruit and vegetable department there will occur during a business day considerable amounts of biowaste, installations are required which dispose of biowaste with a capacity of up to a ton per hour. It has to be taken into consideration here that the waste comes in batches, and then the processing of this biomass has to be carried as continuously as possible in order to reach the required capacities.

Coming from the state of the art the present invention has the object to provide a device which works as economically as possibly, but also reliably.

### BRIEF ABSTRACT OF THE INVENTION

This problem is solved by a device for processing biowaste, consisting of a comminution mill and a separation device for solid materials and liquids arranged after that, a control monitoring pressure and/or flow of the biowaste crumbled by the comminution mill, and, depending on the monitored values, controls a pump arranged before the separation device.

It has been found that the consistence of the mash of biowaste produced by the comminution mill depends to a very high degree on the waste introduced in the device.

However, for a continuous process, in particular for a continuous separation, it is convenient to provide relatively even, physical marginal conditions just in the separation device. The efficiency of the separation device decreases, of course, when the inlet flow of waste mash is accordingly unsteady. If, however, as proposed in the invention, the pressure, respectively the flow of biowaste crumbled in the comminution mill is monitored and a pump arranged before the separation device is adjusted correspondingly depending on these monitored values a continuous supply of the separation device may be secured.

The result is that the separation device is supplied as continuously and evenly as possible so that it can be operated close to its optimal operation point. Therefore it is possible that the separation device is accordingly optimised up to its actually desired waste capacity, and to realise the device altogether also more economically as the separation device has not to be realised too large in order to reach the desired processing capacity.

In addition to that a small separation device, in particular in interaction with a suitable comminution mill, optimised in respect of space can be realised in a common housing, and only the necessary collecting containers and the like have to be placed on the side, if necessary. Thus a device which is possibly highly efficient, but also space saving, is realised for disposing of biowaste.

The control here provides also the base for a common monitoring of the process in the devices according to the invention. The control thus makes it possible that the processing, respectively the disposing, process itself is carried out autonomously, and the accordingly supplied biowaste conveyed in batches is processed step by step. If certain parameters, for example despite increasing the pump capacity, are not reached, the complete device may be switched to trouble for safety purposes and may be switched off.

For monitoring pressure, respectively flow, suitable pressure, respectively flow, sensors are provided. These are located conveniently in the supply pipe for the separation device or in the separation device itself. Flow has to be understood in this connection as the flow of volume or mass of biowaste, respectively mash of biowaste, which passes through a defined cross-sectional area.

In a modification according to the invention it is suggested that a timekeeper is provided for monitoring the flow. Such a modification can be used in particular if the biowaste is expected to be relatively homogenous. The mash of waste resulting from the homogenous biowaste is also relatively uniform, that means homogenous, and its density is known. As long as a corresponding mash is flowing, the pump may be acted on by keeping the time, for example periodically, in order to provide a continuous supply of the separation device.

Furthermore provided a loading sensor is provided for recognising the presence of biowaste in the device. The loading sensor is provided, for example, in the support region, or before, respectively after, the comminution mill, and gives the control corresponding information if there is waste which has to be processed. In particular the loading sensor may act here together with the control in a clever way on the pump; if namely no more biowaste is supplied it will be difficult for the pump to maintain a suitable flow or pressure. A suitable logic is provided in the control.

In a preferred modification of the invention it is provided that the control acts on a liquid valve, and, if necessary, water, respectively liquid, may be added to the biowaste.

It has been found, for example, that ability of biowaste crumbled into mash to be pumped depends significantly on the degree of moisture. If, for example, relatively dry biowaste is brought in the device there may occur the problem that a mass is produced which can only be pumped with difficulties, and in this case of course the flow or pressure which has to be monitored goes down. In such a case it is, for example, provided in the control, if necessary at the same time or after the moisture sensor has determined the moisture of the biowaste, to add water or liquid in a suitable way to the biowaste. For that purpose then the control acts on a suitable mixing valve. By adding liquid the ability of the waste mash to be pumped is influenced positively, and an operation without trouble is secured.

In a modification according to the invention it is also provided here that liquid is added to the biowaste depending on the operational time of the comminution mill. Such a procedure can be used in particular with biowaste as homogenous as possible. The homogeneity here refers in particular to the content of moisture of the waste which has to be processed. If this is known, it will be possible to add liquid accordingly dosed in order to get an optimal consistency. Overdosing would only increase the effort for separation unnecessary. However, if suitable optimal values are known, it is possible to open the mixing valve accordingly and, with reference to the amount of waste, that means to the mass, weight or volume of waste, to add continuously or discontinuously a suitable amount of liquid. This is cleverly done with reference to the duration of operation of the comminution mill, because, logically as long as the comminution mill runs, also corresponding biowaste has to be processed.

The operation of the comminution mill is here, for example, in reference to a loading sensor, which then turns off the comminution mill when no more biowaste is supplied. If the comminution mill is stopped it is not necessary anymore to add liquid, the mixing valve would then be closed.

The invention leaves it open here whether during the complete period of operation of the comminution mill liquid is added, or only in corresponding parts. The addition may be varied also between different types of waste (by the control) which should be as homogenous as possible in such a way that a first valve position which releases a larger liquid flow is assigned to more dry waste material, and a second valve position which adds a smaller amount of liquid is assigned to wetter waste material. Conveniently this is added in the region before the comminution mill or inside, before the actual milling process, in order to generate a waste mash as homogenous as possible for the separation device by the mixing which comes with the grinding.

According to the invention it is provided here that either water or liquid may be used. It is, for example, possible to transport the liquid obtained by the separation process in such a way into a circle again for wetting the biowaste, and thus to use it and save fresh water. Of course, also fresh water may be used.

Furthermore it is provided that the biowaste which has to be processed, respectively to disposed off, can be brought in a support region, and the control is connected with waste recognition sensors in the support region, in order to recognise in particular trouble waste contained in the biowaste. Metal parts and the like hazardous for the mechanic system of the device are trouble waste, and have to be removed reliably out of the biowaste which has to be disposed of before it is processed in the device according to the invention. For that purpose in the support region suitable waste recognition sensors are used, which are based on typical physical effects. If a respective waste recognition sensor signalises the presence of trouble waste the control is able to interrupt the processing operation accordingly, and to run, for example, a trouble sequence, and to alert, for example, the operator in a suitable way (light or sound signal) in order to remove the trouble.

As far as in the frame of this application also a disposal of biowaste is mentioned the disposal has to be understood as a possible modification of processing biowaste. The aim of the invention is in particular to either recycle or process the obtained biowaste in order to make in particular its further use or even its disposal easier. In this respect, this device serves in a special case also for disposing of the biowaste, however, it is not restricted to that.

The introduction of liquid, respectively water, in the biowaste is possible, according to the invention, before as well as after the comminution mill.

According to the invention it is provided that, arranged after the separation device, one collecting container each for solid material and/or liquid is provided, and the control is connected actively with level sensors in the collecting containers. The invention does not define whether a collecting container for solid material as well as a collecting container for liquids is necessarily provided. It may be possible that only one collecting container is provided, and, for example, the liquid is disposed of directly in the drain. For an operation as automatically as possible it is convenient that the control is also informed of the level of the respective present collecting container, for which purpose suitable level sensors are used. When only one sensor indicates that a collecting container has reached a threatening level, via the control, for example, the supply of fresh waste mash may be throttled or stopped by the pump, or, for example, the support regions may be closed off accordingly. In this case also an accident would result, and the operator would then be requested to empty the collecting containers. Therefore the invention provides as a result that the control, depending on the information transmitted by the waste recognition sensor, respectively the level sensor, adjusts, throttles or stops the processing capacity of the device altogether, respectively only the separation device or other parts, respectively starts a trouble sequence.

It is also inconvenient if, for example, synthetic material is brought in the device as synthetic material obstructs afterwards during the processing, respectively disposal, operation. It is also possible to design the waste recognition sensor in such a way that the quality of the introduced biowaste is monitored. For that, for example suitable moisture sensors or even conductibility sensors are possible, by means of which the respective quality of the deposited biowaste may be concluded.

In the design of the control in a trouble sequence, for example, the comminution mill is stopped, and the pump conveys still present, already crumbled biomass to the separation device. The trouble sequence therefore empties the device in order to make, for example, maintenance or cleaning, easier. If necessary, however, instead of the trouble sequence an emergency sequence may be triggered so that, for example, an emergency stop is generated.

Because, as already described in the beginning, a considerable part of the obtained biomass is liquid, and the liquid is used, for example for wetting the biomass, respectively the crumbled biomass, in the circle, it is convenient to provide a liquid recycling system for the liquid. The reason is in particular because, with the use of a biological water recycling, the material precipitated from the liquid may be used in the biowaste processing device according to the invention, and, on the other hand, accordingly pre-cleaned water relieves the sewerage correspondingly.

It has been found to be convenient that the control adjusts the pump rate of the pump. The pump is operated in such a way that a time interval is subdivided in a pump rate and a break.

This time interval is repeated unlimitedly. If now the control realises that the flow is below the desired values the pump rate is increased accordingly, the break part reduced accordingly. Then a control adjustment circle is obtained with the purpose to reach the desired values of flow, respectively pressure.

The use of a control has also the advantage that start and stop sequence in the control can be recalled, and, during the start sequence, in particular first of all the comminution mill, after that the pump, and in the end the separation device is started, and in the stop sequence an after-running of the separation device is carried out with respect to the run of the comminution mill. In such a design, on the one hand, energy is saved, as at the start process not all elements have to run simultaneously if not all elements are supplied with material which has to be processed. If necessary the single elements are started according to fixedly set time intervals, or there are suitable recognition sensors which inform the control that, for example, the pump, respectively the separation device, has to be started.

Besides saving energy, however, a protection of the device itself is obtained as dry running of the device is avoided.

Advantageously a rinsing sequence is provided in the control during which the complete device can be cleaned with fresh water. It is provided her that suitable cleaning agents or even disinfectants are added to the fresh water in order to reach a suitable rinsing, respectively cleaning, or even disinfection of the complete device. This is recommendable in particular for hygienic reasons, and makes the cleaning of the device according to the invention considerably easier. The control acts here in a suitable way on the valves which supply the fresh water, also the addition of the cleaning agents or disinfectants can be mastered accordingly by the control.

An essential part of the invention is also the fact that a cleaning sequence of the separation device is provided which can be applied by the control, for example, during operation, in particular for maintenance purposes, or also in the rinsing or stop sequence. As in a separation device liquid and solid material is separated from the waste mash, it is convenient to provide a regular cleaning sequence only for the separation device for a trouble-free operation of the separation device, and thus to forestall maintenance or repair which would be necessary otherwise. The cleaning sequence is carried out here, for example for maintenance purposes, automatically, for example depending on the time of operation or the processed volume. It contains here an individual cleaning process which is only aimed at the separation device, and where the cleaning sequence has to be carried out also as part of the rinsing sequence or at the end of the stop sequence.

The advantage of the invention is in particular the fact that the sequences mentioned above are designed module-like, and can be used and recalled on demand by the control.

It is, of course, also possible to install a suitable cleaning sequence for the comminution mill.

For the case that an accident is determined by the control, for example by the waste recognition sensors or the level sensors, it is possible and even convenient that the control starts a trouble sequence where the control stops the comminution mill, and the pump conveys still present crumbled biowaste mash to the separation device, the separation device still separates it accordingly, and, after that, the control carries out, if necessary a cleaning sequence. For the case that the level sensors point to an accident, of course, a suitable reserve has to be provided in order to allow a complete emptying of the device. Stopping the comminution mill interrupts the supply of waste mash, for the case that impurities or troubling waste are found in the support region, an early stopping of the comminution mill protects it.

Advantageously the pump is designed as impeller pump. Impeller pumps have the advantage that they are designed indifferently on the position, and that they are dry, self-priming.

Therefore they may even in empty condition apply the complete device.

The invention refers also to a method for processing biowaste, the biowaste being crumbled, respectively ground, in a comminution mill, and a separation device arranged after that separating the crumbled biowaste into solid material and liquids, pressure and/or flow of the ground biowaste being monitored and, if necessary, the pressure, respectively the flow, of the ground biowaste being adjusted, in particular increased or reduced, by a pump. In such a method according to the invention the secure, trouble-free and also automatic operation is secured, and a constant load of the separation device is reached, so that as a last consequence it has not to be over-dimensioned in order to intercept corresponding processing peaks.

In this connection it is pointed out specifically that all characteristics and features described with reference to the device, however, however, all methods accordingly can be transferred with reference to the formulation of the method according to the invention, and can be used in the sense of the invention and are seen as disclosed. The same goes vice versa, that means that only constructive, that means device, characteristics mentioned with reference to the method may also be taken into consideration in the frame of device claims and be claimed, and also count to the invention and disclosure.

### BRIEF DESCRIPTION OF THE DRAWINGS

In the single drawing the invention is shown schematically in a block diagram.

### DETAILED DESCRIPTION OF THE PREFERRED EMBODIMENT

The device according to the invention can be described as follows. The biowaste is deposited in the support region 1. Through the connection drawn as pipe 22 it gets in the comminution mill 2. The comminution mill 2 generates a waste mash the ability of which to be pumped or flow depends essentially on the size of the water content of the introduced good.

The direction of conveying of the biowaste, the liquid and so on is indicated by arrows.

The waste mash produced in comminution mill 2 is conveyed through the suction pipe 23, the pump 3 and a pump pipe 24 in the separation device 4. The separation device 4 effects a separation of the solid material from the liquid contained in the waste mash. Collecting container 5 is available for the solid material. Also for liquids a collecting container is provided with the reference number 6.

The separation device 4 is designed, for example, as press or the like.

The liquid collected in the collecting container 6 is also guided, if necessary, via a liquid pump 7 in a liquid recycling system 8, and can then be let out via the wastewater valve 11, for example, in the drain channel 9. The wastewater valve 11 is connected via the control line 20 with the control.

It is, of course, possible to do without the arrangement of a liquid pump 7 and a liquid recycling system 8, and to conduct the liquid on the side of the outlet on the separation device 4 directly in the drain channel 9.

According to the invention it has been found to be favourable to secure a flow stream as continuous as possible to the separation device 4. As the further conveying of the waste mash coming out of the comminution mill 2 is not monitored or controlled, but is left, for example, to the gravity or the pump capacity of the comminution mill 2, it is now suggested in the invention to arrange a pump 3 in the region between the comminution mill 2 and the separation device 4, and to adjust the pump 3 by the control 13 in such a way that the separation device 4 is supplied as optimal as possible with waste mash which has to be separated.

For that purpose a sensor line 17 is provided which measures the physical parameters pressure and/or flow (these are here the volume or mass flow of the waste mash), and transmits them via the line 17 to the control 13. Because of the parameters determined by suitable sensors and the criteria set in the control 13 it is now possible to adjust the pump 3 accordingly and to set an optimal supply to the separation device 4.

For that purpose the pump 3 is connected via the control line 16 with the control 13.

Line 17, however, makes it also possible to control at the same time the separation capacity of the separation device 4 through the control 13. Other possibilities present themselves by that through the use of the control. It is, for example, possible, to manage and carry out in a controlled manner according start or stop sequences, or even trouble sequences and emergencies and so on with the control.

It has been found in particular that, if too dry waste is introduced, the biowaste is mixed with liquid or water. For example, a first mixing valve 12 is provided which makes it possible to introduce liquid out of the liquid supply pipe 10 in the conduct 22 between support region 1 and comminution mill 2.

The same is possible, for example, also with the second mixing valve 12′ through which fresh water may be introduced via the fresh water pipe 25. For that purpose control 13 is equipped with a suitable control line 21, 21′ through which the control 13 can control and adjust the mixing valves 12, 12′. This may be used, for example, also for cleaning processes.

It is here, according to the invention, identical whether the supply pipes for the liquids, respectively the fresh water, are designed as indicated, or whether they run already in the support region 1, that means they also net it or clean it, if necessary, or first of all they run in the comminution mill 2. It has to be taken into consideration here that the addition of water, respectively liquid before the comminution mill 2 results in particular in an additional mixing effect, and leads to a more homogenous and thus easier to pump waste mash after the comminution mill 2. However, it is also possible to arrange the water, respectively the liquid, after the comminution mill 2.

Conveniently a sensor line 14 is provided which connects the control 13 with the waste recognition sensors in the support region 1. Depending on the determined kind of waste, respectively quality of waste, the control can prepare and start corresponding procedures of processing, or in the case that trouble waste is found suitable trouble or emergency sequences or programmes can be activated. In such a case then the comminution mill 2 is accordingly adjusted or even stopped via the control line 15, the pump 3 via the control line 16, and the separation device 4 via the sensor control line 17, respectively they are stopped in a controlled way or reduced in their power.

In order to complete it is provided that also the liquid pump 7 as well as the liquid recycling system 8 are connected with the control 13 via suitable control lines 18, 19, and also the control can influence, if necessary, these elements in this way.

Also the wastewater valve 11 which connects the liquid circle with the drain 9 can be controlled and adjusted through the control 13.

The claims filed with the application now and to be filed later on are attempted formulations without prejudice for obtaining a broader protection.

If here, on closer, examination in particular also of the relevant state of the art, it turns out that one or the other feature may be convenient for the aim of the invention, however, not decisively important, of course, already now a formulation is striven for which does not contain anymore such a feature, in particular in the main claim.

References in the sub-claims relate to the further design of the matter of the main claim through the characteristics of the respective sub-claim. These are, however, not to be understood as a waiver of independent protection of the matter for the characteristics of the referred sub-claims.

Characteristics only disclosed in the description so far may now, in the course of proceedings, be claimed as being of inventive relevance, for example to distinguish from the state of the art.

Characteristics only disclosed in the description or even single characteristics from claims which comprise a variety of characteristics may be used at any time to distinguish from the state of the art in the first claim, and this is even if such characteristics have been mentioned in connection with other characteristics, respectively achieve particularly convenient results in connection with other characteristics.

Although the invention has been described by exact examples which are illustrated in the most extensive detail, it is pointed out that this serves only for illustration, and that the invention is not necessarily limited to it because alternative embodiments and methods become clear for experts in view of the disclosure. Accordingly changes can be considered which can be made without departing from the contents of the described invention.

1. Device for processing biowaste, comprising a comminution mill and a separation device arranged after it for solid materials and liquids, characterised in that a control (13) monitors pressure and/or flow of the biowaste ground by the comminution mill (2), and adjusts, depending on these monitored values, a pump (3) arranged before the separation device (4).

2. Device according to claim 1, characterised in that the pressure and/or the flow in the supply pipe (24) to the separation device (4) or in the separation device (4) is monitored.

3. Device according to claim 1, characterised by a time keeper of the flow monitoring.

4. Device according to claim 1, characterised by a loading sensor for recognising the presence of biowaste in the device.

5. Device according to claim 1, characterised in that the control (13) acts on a liquid valve (12, 12′), and, if necessary, water, respectively liquid, may be added to the biowaste.

6. Device according to claim 1, characterised in that liquid is added to the biowaste depending on the period of operation of the comminution mill (2).

7. Device according to claim 1, characterised in that the biowaste which has to be disposed of can be brought in a support region (1), and the control (13) is connected actively with at least one biowaste recognition sensor in the support region (1) in order to recognise in particular trouble waste contained in the biowaste.

8. Device according to claim 1, characterised in that after the separation device (4) one collecting container (5, 6) each for solid material and/or liquid is provided, and the control (13) is connected with level sensors in the collecting containers (5, 6).

9. Device according to claim 1, characterised in that the biowaste which has to be disposed of can be brought in a support region (1), and the control (13) is connected actively with at least one waste recognition sensor in the support region (1) in order to recognise in particular trouble waste contained in the biowaste, and the control (13) adjusts, throttles or stops, depending on the information transmitted by the waste recognition sensor, the processing capacity of the complete device, respectively the separation device (4), respectively starts a trouble sequence.

10. Device according to claim 1, characterised in that after the separation device (4) one collecting container (5, 6) each for solid material and/or liquid is provided, and the control (13) is connected actively with level sensors in the collecting containers (5, 6), and, the control, depending on the information transmitted by the level sensor, adjusts, throttles or stops the processing capacity of the complete device, respectively the separation device (4), or starts a trouble sequence.

11. Device according to claim 1, characterised by a liquid recycling system (8) for the liquid.

12. Device according to claim 1, characterised in that a fresh water supply (25) is provided.

13. Device according to claim 1, characterised in that the control (13) adjusts the pump rate of the pump (3).

14. Device according to claim 1, characterised in that in the control (13) start and stop sequences can be recalled, and the control (13) starts, first of all, during the start sequence the comminution mill, after that the pump, and in the end the separation device, and in the stop sequence carries out an after-running of the separation device (4) with respect to the run of the comminution mill (2).

15. Device according to claim 1, characterised by a rinsing sequence in the control (13) in which the complete device can be rinsed with fresh water.

16. Device according to claim 1, characterised by a cleaning sequence of the separation device (4) which can be used by the control (13), for example during operation, in particular for maintenance purposes, or in the rinsing or stop sequence.

17. Device according to claim 1, characterised in that in a trouble sequence the control (13) stops the comminution mill (2), and the pump (3) conveys still present, crumbled biomass to the separation device (4), and, after that, the control (13), if necessary, carries out a cleaning sequence.

18. Device according to claim 1, characterised in that the pump (3) is designed as impeller pump.

19. Method for processing biowaste, where biowaste is crumbled, respectively ground, in a comminution mill, and a separation device arranged after that separates the crumbled biowaste into solid material and liquids, where pressure and/or flow of the ground biowaste is monitored, and, if necessary, the pressure, respectively the flow, of the ground biowaste is adjusted by a pump, in particular increased or reduced.
